(19) United States
(12) Patent Application Publication
(10) Pub. No.: US 2025/0343469 A1
(43) Pub. Date: Nov. 6, 2025

(54) ELECTRIC MOTOR WITH LIQUID COOLING OF ENDRING

(71) Applicant: Atieva, Inc., Newark, CA (US)

(72) Inventors: Shuqi Cheng, Fremont, CA (US); Mahsaalsadat Mortazavi Ravari, Redwood City, CA (US); Shun-Cheng Hung, Taipei City (TW); Yajat Vedant Pandya, Fremont, CA (US); Michael Abosch, San Carlos, CA (US); Lukas Bartmann, Newark, CA (US); Calahan Benjamin Campton, Fremont, CA (US)

(21) Appl. No.: 18/655,980

(22) Filed: May 6, 2024

(51) Int. Cl. H02K 9/19

(52) U.S. Cl. CPC H02K 9/19

(57) ABSTRACT

An electric motor comprises: a stator, a rotor comprising: a rotor shaft having a hollow interior and configured for rotation inside the stator about a rotor axis, the rotor shaft having at least one inlet into the hollow interior and at least one radial outlet from the hollow interior, and a rotor body and an endring at an end of the rotor body along the rotor axis; and a spacer forming an internal cavity to receive fluid from the hollow interior, the spacer having an outlet from the internal cavity.

### TECHNICAL FIELD

This document relates to an electric motor with liquid cooling of one or more endrings.

### BACKGROUND

In recent years, the world's transportation has begun a transition away from powertrains primarily driven by fossil fuels and toward more sustainable energy sources. The majority of such increasingly prevalent powertrains include electric motors powered by on-board energy storages. Electric motors generate heat during operation, and their efficiency and other performance characteristics in part depend on the thermal control strategy.

### SUMMARY

In an aspect, an electric motor comprises: a stator; a rotor comprising: a rotor shaft having a hollow interior and configured for rotation inside the stator about a rotor axis, the rotor shaft having at least one inlet into the hollow interior and at least one radial outlet from the hollow interior; and a rotor body and an endring at an end of the rotor body along the rotor axis; and a spacer forming an internal cavity to receive fluid from the hollow interior, the spacer having an outlet from the internal cavity.

Implementations can include any or all of the following features. The rotor shaft has multiple radial outlets from the hollow interior. The multiple radial outlets are axisymmetrically distributed around a circumference of the rotor shaft. The multiple radial outlets are evenly distributed around the circumference of the rotor shaft. The spacer is an annular element positioned around the rotor shaft, and wherein the internal cavity forms an annulus inside the spacer. The outlet from the internal cavity is positioned radially inward of a radially outermost portion of the annulus. The endring has a stepped profile that includes concentric steps. A distance of each of the concentric steps from the rotor body increases with increasing diameter of the concentric steps. The spacer is integrated into the endring, wherein the internal cavity is formed in the endring, and wherein the outlet from the internal cavity faces away from the rotor body along the rotor axis. The electric motor further comprises pins on the endring, wherein the spacer abuts the pins, and wherein after the fluid exits the internal cavity the fluid flows through gaps between the pins. The pins project parallel with the rotor axis. The electric motor further comprises pin fins at some or all of the concentric steps. The pin fins project parallel with the rotor axis. The pin fins are angularly equally spaced from each other on at least one of the concentric steps. A first group of the pin fins are aligned with each other in a first radial direction from the rotor axis, and wherein a second group of the pin fins are aligned with each other in a second radial direction from the rotor axis. The pin fins have different heights. The pin fins have cylindrical shapes. The first group of the pin fins are positioned on odd-numbered ones of the concentric steps. The second group of the pin fins are positioned on even-numbered ones of the concentric steps. Each of the pin fins straddles adjacent ones of the concentric steps. A profile of the spacer has a shape of a lowercase letter h, the profile including (i) an ascender portion extending in a radial direction from the rotor axis and (ii) an arch portion connected to the ascender portion. The ascender portion abuts the endring. The arch portion at least partially forms the outlet from the internal cavity. The spacer is integrated into the endring, wherein the internal cavity is formed in the endring, and wherein the outlet from the internal cavity faces away from the rotor body along the rotor axis. The electric motor further comprises fins on the endring. The fins project parallel with the rotor axis. The fins form circular arcs that are concentrically arranged with regard to the rotor axis. Respective angular positions of the circular arcs with regard to the rotor axis are staggered from each other. The fins form arcs on the endring. Each of the arcs begins at a common diameter with regard to the rotor axis. At least one of the arcs has a varying height parallel with the rotor axis. At least one of the arcs includes arc segments separated by gaps. Each of the arcs is substantially linear. The arcs have different orientations from each other. The fins are pin fins. The fins form a diamond pattern on the endring. The endring has a stepped profile that includes concentric steps, the electric motor further comprising arcs on the concentric steps. The arcs project parallel with the rotor axis. A distance of each of the concentric steps from the rotor body increases with increasing diameter of the concentric steps. The outlet from the internal cavity is at least partially bounded by the rotor shaft. The radial outlet from the hollow interior is positioned between the end of the rotor body and an opposite end of the rotor body, the electric motor further comprising an axial channel coupled to the radial outlet from the hollow interior, the axial channel positioned between the rotor body and the rotor shaft. The radial outlet from the hollow interior is positioned in a middle between the end and the opposite end. The axial channel is at least partially formed by a female key in the rotor body. The spacer is positioned on the rotor shaft adjacent the endring, and wherein the outlet faces toward the rotor body along the rotor axis. The spacer has an inlet to the internal cavity, the inlet facing toward the rotor body along the rotor axis and being coupled to the axial channel. The spacer is an annular element positioned around the rotor shaft, and wherein the internal cavity forms an annulus inside the spacer. A depth of the annulus from an outer diameter of the rotor shaft varies with angular position about the rotor axis. The radial outlet from the hollow interior is a first radial outlet from the hollow interior, wherein the endring is a first endring, wherein the spacer is a first spacer, wherein the internal cavity is a first internal cavity, wherein the outlet from the internal cavity is a first outlet, the electric motor further comprising: a second radial outlet from the hollow interior; a second endring positioned at an opposite end of the rotor body along the rotor axis; and a second spacer forming a second internal cavity to receive the fluid from the hollow interior, the second spacer having a second outlet from the second internal cavity. The first endring and the second endring are identical to each other. The second spacer is positioned on the rotor shaft adjacent the second endring, and wherein the second outlet faces toward the rotor body along the rotor axis. The fluid includes oil. The electric motor is an induction motor. Differential gears are positioned in the hollow interior. The radial outlet extends into the hollow interior.

### BRIEF DESCRIPTION OF DRAWINGS

FIG. 1A schematically shows an example of a rotor for an electric motor, the rotor having liquid cooling of one or more endrings.

FIG. 1B schematically shows an example of an electric motor.

FIG. 2 shows an example of a cross section of a rotor.

FIG. 3 shows an example of an endring that can be used with an electric motor.

FIG. 4 shows another example of an endring that can be used with an electric motor.

FIG. 5 shows another example of an endring that can be used with an electric motor.

FIG. 6 shows another example of an endring that can be used with an electric motor.

FIG. 7 shows another example of an endring that can be used with an electric motor.

FIG. 8 shows another example of an endring that can be used with an electric motor.

FIG. 9 shows another example of an endring that can be used with an electric motor.

FIG. 10 shows another example of an endring that can be used with an electric motor.

FIG. 11 shows another example of an endring that can be used with an electric motor.

FIG. 12 shows another example of an endring that can be used with an electric motor.

FIG. 13 shows another example of an endring that can be used with an electric motor.

FIG. 14 shows an example section of a rotor having a rotor shaft with a spacer.

FIG. 15 shows an example section of the spacer of FIG. 14.

FIG. 16 shows another example section of the electric motor of FIG. 14.

FIG. 17 shows an example section of a rotor.

FIG. 18 shows an example of a spacer that can be used with the rotor of FIG. 17.

FIG. 19 shows another example section of the spacer of FIG. 18.

FIG. 20 shows another example section of the rotor of FIG. 17.

FIG. 21 shows another example section of the rotor of FIG. 17.

FIG. 22 shows another example section of the spacer of FIG. 18.

FIG. 23 shows another example of a rotor.

FIG. 24 shows an example section of the rotor of FIG. 23.

FIG. 25 shows an example section of a rotor having radial outlets that are axisymmetrical.

Like reference symbols in the various drawings indicate like elements.

### DETAILED DESCRIPTION

This document describes examples of systems and techniques for providing thermal control of an electric motor using liquid cooling of one or more endrings. The endring(s) can serve as a rotary heat sink for the electric motor. For example, oil (or another non-conductive liquid) can be flowed at the end(s) of the rotor to extract heat.

In some implementations, oil flow can be directed towards added heat sinks located at the axial ends of an induction motor rotor. As such, heat can be extracted from the rotor by an oil flow, using the rotary heat sinks at the ends of the rotor. A spacer can be provided at the inner diameter of the rotary heat sinks. Oil flow over the rotary heat sink can be imposed by centrifugal forces. A well distributed oil flow over the rotary heat sink can be created that maximizes heat extraction.

In prior approaches, some electric machine rotors have been provided with oil flow in the shaft, which provides a degree of rotor cooling through the shaft. Some induction motor rotor designs have provided fins on the endrings for air cooling similar to fans. Some prior approaches have passed the shaft oil to the endrings but these have been subject to uneven liquid distribution and inefficiency in the heat sink.

Examples described herein refer to an electric motor. As used herein, an electric motor can be any type of electric motor, including, but not limited to, an induction motor, a synchronous motor (e.g., a permanent-magnet motor or a wound field synchronous motor), or a reluctance motor.

In some examples described herein, an induction motor rotor is used as an example of an application where liquid cooling of one or more endrings can be performed. In some implementations, other types of electric motor rotors can be used, including but not limited to interior permanent magnet machine rotors. Induction motor rotors can include bars and endrings that pass electric current through, in addition to steel laminations which form the rotor core. Bars for conducting current are positioned along the whole rotor stack length to connect the two endrings at the two axial ends of the rotor. Most of the heat is generated in the bars and endrings parts. The generated heat is conducted through the endrings, bars, and the steel laminations and is eventually extracted through convection to a cooling fluid. In some implementations, endrings can be designed to operate as rotating heat sinks. The endrings can be made of high conductive materials and can advantageously be used as heat sinks. The cooling fluid on the designed heat sinks can include oil. Oil flow on the rotating heat sinks can be imposed by rotational forces-mainly centrifugal forces. Heat sinks described herein can be optimized for the best heat extraction rate, considering the dominant forces.

Oil routing to the rotary heat sinks can be conducted through any of multiple different strategies. One approach is to redirect the oil in the shaft to the rotary heat sinks. That can involve modifying the shaft design and adding openings in the shaft that can pass the oil in the shaft radially outwards on the rotary heat sinks. As such, it is possible to pass oil from inside the rotor core to the rotary heat sinks.

Using the present subject matter, heat extraction can be achieved at the endring location. Extracting heat at the endrings can be desirable since heat is mainly produced in the endrings and bars. By extracting heat at the endrings one can minimize the distance between heat sink and a section of the heat source, i.e., the endrings. Since the thermal conductivity of the endrings and bars is high, heat transfer from other parts of the heat source (i.e., different parts of the bars) to the endrings (the location of the heat sink) can be very efficient with minimal thermal resistance. That allows for an efficient heat extraction and a decrease in induction motor rotor temperatures. As a result, these designs can be advantageous compared to other designs in which heat extraction is achieved farther away from the heat source, for example inside the shaft. Additionally, oil can be used as the cooling fluid, which has higher thermal conductivity and thermal mass compared to air. As a result, higher heat extraction rates can be achieved compared to other designs that use air as a cooling medium.

The rotary heat sink and spacer geometries in such designs can be optimized to maximize heat extraction rates with a given oil flowrate in a range of rotational speeds. Consequently, minimal oil flowrates can lead to considerable heat extraction rates and convection coefficients at the rotary heat sinks. This can allow the induction motor rotor to operate at lower temperatures, improving the induction motor's performance. Additionally, by minimizing the oil flowrate, the windage losses caused by oil flow can be minimized, which leads to higher efficiencies.

More particularly, a heat transfer coefficient (HTC) multiplied by the area (A) of the heat sink (HTC*A) is a measure of efficacy of the heat extraction rate. Computational fluid dynamics simulations show that by a designed rotary heat sink and spacer, HTC*A can increase by about 140% compared to a base design at the same flowrate and rotational speed. The base design is the initial endring design with no thermal modifications, and three openings at the shaft directing the oil in the shaft radially outwards to the endrings. In other words, at the same oil flowrate and rotor rotational speed, the thermal modifications in the endring (i.e., a rotary heat sink design) and the addition of the spacer, can increase HTC*A by 140% from the baseline that does not have the mentioned design alterations.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

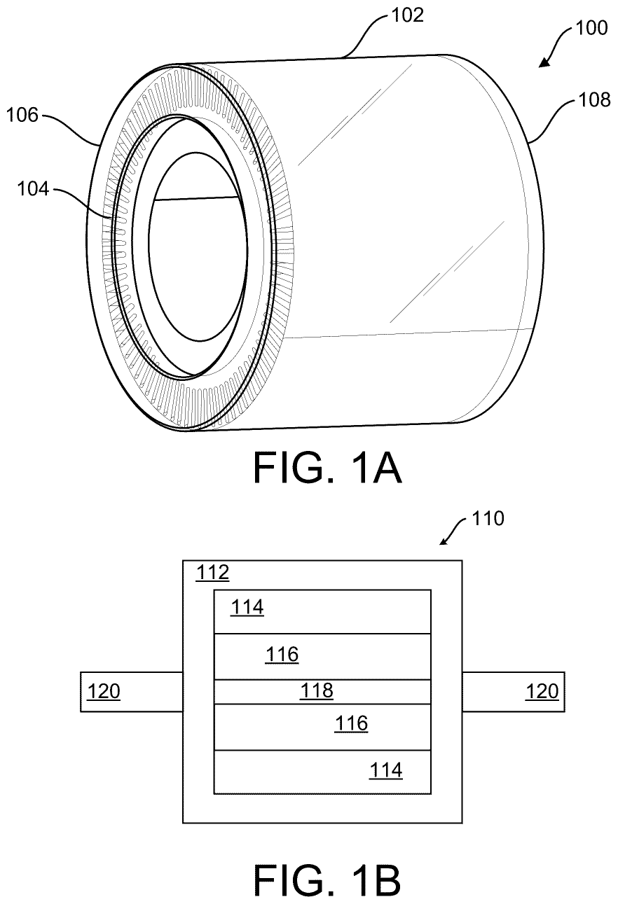

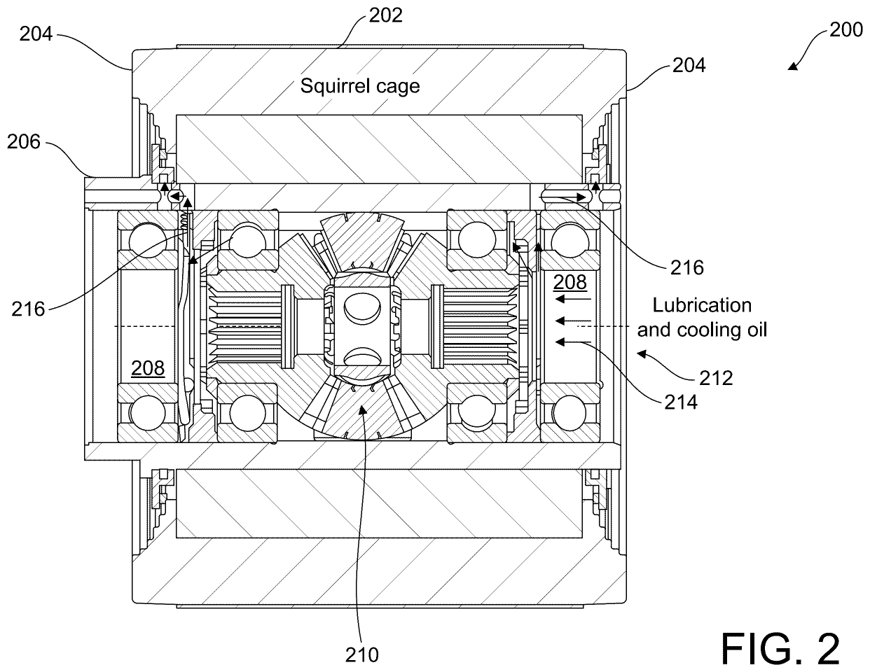

FIG. 1A schematically shows an example of a rotor 100 for an electric motor, the rotor 100 having liquid cooling of one or more endrings. The rotor 100 can be used with one or more other examples described elsewhere herein. The rotor 100 includes a rotor body 102 configured for rotation about a rotor axis using a rotor shaft (not shown for clarity). In some implementations, the rotor body 102 is formed of a stack of rotor laminations made of one or more materials. The stack can include one or more types of rotor laminations. The rotor 100 can be configured for use in an induction motor and can include bars 104 substantially parallel with each other. The bars 104 can be at least substantially parallel with the rotor axis. For example, in a skewed rotor design, the bars 104 can form a nonzero angle with the rotor axis. The bars 104 can be made of metal, including, but not limited to, aluminum (e.g., an alloy). The rotor 100 can include endrings 106, 108 at opposing axial ends of the rotor body 102. The endring 106 is here shown transparent for clarity. The endrings 106, 108 can be made of metal, including, but not limited to, aluminum (e.g., an alloy). The endrings 106, 108 and the bars 104 can together form a cage structure (e.g., a so-called squirrel cage). The endrings 106, 108 can be used as heat sinks for liquid cooling of the rotor 100. A liquid (e.g., oil) can be flowed onto either or both of the endrings 106, 108 to reject heat.

FIG. 1B schematically shows an example of an electric motor 110. The electric motor 110 can be used with one or more other examples described elsewhere herein. The electric motor 110 has a motor housing 112 with a stator 114 and a rotor 116 within the motor housing 112. For example, the rotor 100 (FIG. 1A) can be the rotor 116. The rotor 116 is coupled to a rotor shaft 118 so as to be rotatable about a rotor axis. The electric motor 110 can rotate the rotor shaft 118 in one direction to drive the vehicle forward using a differential inside the rotor shaft 118. In other implementations, the differential may instead be positioned outside the rotor shaft 118. The electric motor 110 has one or more output shafts 120. For example, the output shaft 120 can be coupled to a wheel axle (e.g., welded to a drive shaft) or any other load to be driven by the electric motor 110. In some implementations, the electric motor 110 is an induction motor.

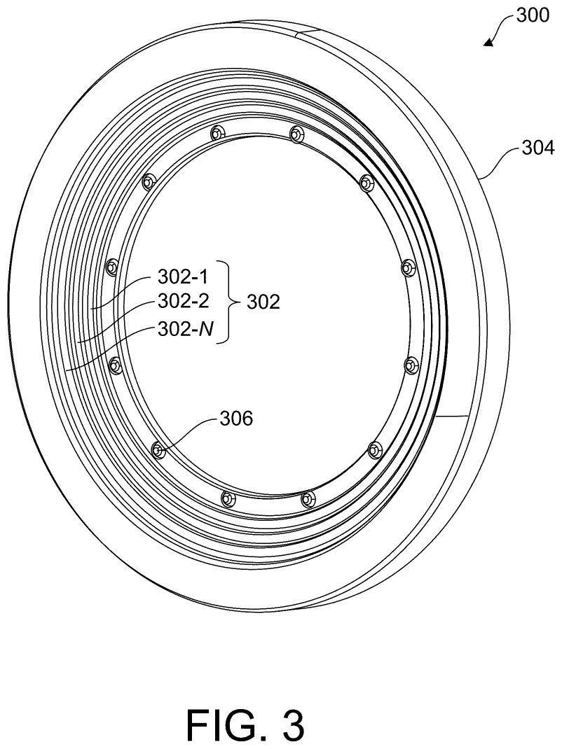

FIG. 2 shows an example of a cross section of a rotor 200. The rotor 200 can be used with one or more other examples described elsewhere herein. The rotor 200 includes a rotor body 202, endrings 204, and a rotor shaft 206 having a hollow interior 208. Differential gears 210 can be positioned in the hollow interior 208. In other implementations, differential gears may instead be positioned outside the hollow interior 208.

The rotor shaft 206 has an inlet 212 into the hollow interior 208. The inlet 212 can facilitate routing of a liquid through the rotor 200 in a flow 214 for thermal control. In the hollow interior 208, oil that enters through the inlet 212 can lubricate the differential gears 210. From the differential gears 210, the flow 214 can be directed toward the endrings 204 as at least one flow 216. The flow 216 can be facilitated by a radial outlet in the rotor shaft 206 that allows the liquid to flow out of the hollow interior 208 by centrifugal action. When multiple radial outlets are used, they can be positioned axisymmetrically about the rotor axis. For example, in the rotor 200 the axisymmetrically positioned radial outlets are evenly spaced about the rotor axis. Here, two instances of the flow 216 are shown to illustrate that the rotor shaft 206 can have multiple radial outlets from the hollow interior 208.

FIG. 3 shows an example of an endring 300 that can be used with an electric motor. The endring 300 can be used with one or more other examples described elsewhere herein. The endring 300 can be provided on a rotor body as a heat sink. The endring 300 is an annular component at the rotor body. For example, the endring 300 can be an integral component (e.g., die-cast together) with bars of the rotor body. In some implementations, the endring 300 can instead be mounted to the rotor body. For example, two different materials can then be used for the endring 300 and the bars of the rotor body. The endring 300 has a stepped profile. The stepped profile includes concentric steps 302. Concentric steps 302-1, 302-2, . . . , 302-N can be used, where N=2, 3. Each of the concentric steps 302 can have any of multiple shapes. With a side 304 of the endring 300 facing the rotor body, the concentric steps 302 can at least in part be characterized by their respective distances from the rotor body. In some implementations, the concentric steps 302 have heights such that their respective distances increase with increasing diameter of the concentric steps 302. For example, the concentric step 302-N has a greater diameter, and therefore has a greater height, than the concentric step 302-1. Other approaches can be used.

One or more pins 306 can be provided on the endring 300. The pins 306 can project parallel with the rotor axis. Here, the pins 306 project in a direction away from the rotor body. For example, the pins 306 can be positioned on an innermost one of the concentric steps 302. The pins 306 can be used when a spacer (e.g., as described below) is used for distributing liquid onto the endring 300 for cooling. For example, the pins 306 can provide structural support between the endring 300 and the spacer. Liquid can flow through gaps between the pins 306 in order to be distributed onto the endring 300.

An instance of the endring 300 can be positioned at either or both axial ends of a rotor body. Whether the rotor has one or two endrings, the endring 300 can be used for balancing. For example, material can be removed from one or more locations of the endring 300 in a balancing process to adjust the position of the rotor's center of gravity. As such, when two instances of the endring 300 are used on a rotor they can be identical or different from each other.

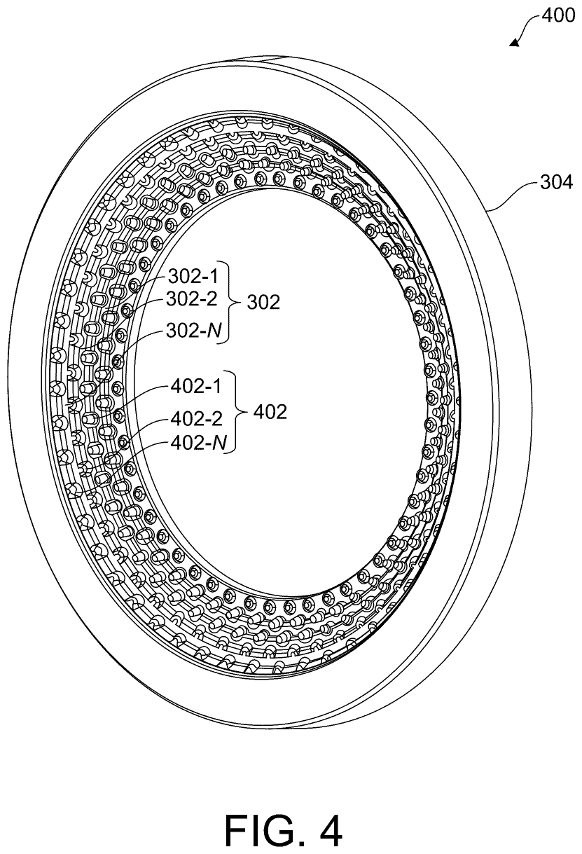

FIG. 4 shows another example of an endring 400 that can be used with an electric motor. The endring 400 can be used with one or more other examples described elsewhere herein. The endring 400 can include some or all features of the endring 300 (FIG. 3), except as discussed in the following.

The endring 400 has pin fins 402 on some or all of the concentric steps 302. Here, pin fins 402-1 are shown on the concentric step 302-1, pin fins 402-2 are shown on the concentric step 302-2, and pin fins 402-N are shown on the concentric step 302-N. The pin fins 402 can project in a direction that can be parallel with the rotor axis. In some implementations, the pin fins 402 can form a nonzero angle with the rotor axis. For example, the pin fins 402 can be oriented in a direction away from the side 304 of the endring 400. On one or more of the concentric steps 302, the pin fins 402 can be angularly equally spaced from each other. A first group of the pin fins 402 can be aligned with each other in a first radial direction from the rotor axis (e.g., at a twelve o'clock position on the annular structure). In some implementations, the first group of the pin fins 402 are positioned on the odd-numbered ones of the concentric steps 302. For example, one of the pin fins 402-1 on the concentric step 302-1 (e.g., the first step) can be aligned with one of the pin fins 402 on the next odd-numbered one of the concentric steps 302 (e.g., the third step), and so on. A second group of the pin fins can be aligned with each other in a second radial direction from the rotor axis (e.g., at slightly past the twelve o'clock position on the annular structure). In some implementations, the second group of the pin fins 402 are positioned on the even-numbered ones of the concentric steps 302. For example, one of the pin fins 402-2 on the concentric step 302-2 (e.g., the second step) can be aligned with one of the pin fins on a next even-numbered step (e.g., the fourth step), and so on. Other approaches can be used.

The pin fins 402 can have the same heights from their respective concentric steps, or different heights. In some implementations, the heights of some or all of the pin fins 402 can be designed so as to provide clearance for other parts inside the housing of the electric motor. The pin fins 402 can have any shape. Here, the pin fins 402 have cylindrical shapes.

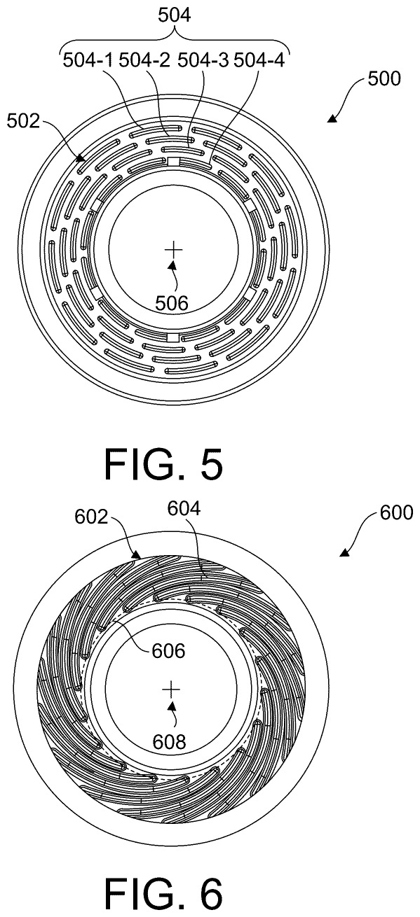

FIG. 5 shows another example of an endring 500 that can be used with an electric motor. The endring 500 can be used with one or more other examples described elsewhere herein. The endring 500 has an annular shape and includes fins 502. The fins 502 project in a direction that can be parallel with the rotor axis. In some implementations, the fins 502 can form a nonzero angle with the rotor axis. For example, the profile of an individual one of the fins 502 can be a triangular shape. The fins 502 can form circular arcs 504 that are concentrically arranged with regard to a rotor axis 506. Angular positions of the circular arcs 504 around the rotor axis 506 can be staggered from each other. For example, angular positions of circular arcs 504-1, 504-2, 504-3 and 504-4 506 with regard to the rotor axis can be staggered from each other.

FIG. 6 shows another example of an endring 600 that can be used with an electric motor. The endring 600 can be used with one or more other examples described elsewhere herein. The endring 600 has an annular shape and includes fins 602. The fins 602 project in a direction that can be parallel with the rotor axis. In some implementations, the fins 602 can form a nonzero angle with the rotor axis. The fins 602 can form arcs 604. In some implementations, each of the arcs 604 begins at a common diameter 606 with regard to a rotor axis 608. For example, each of the arcs 604 can have substantially the same lead angle at the common diameter 606 as each other.

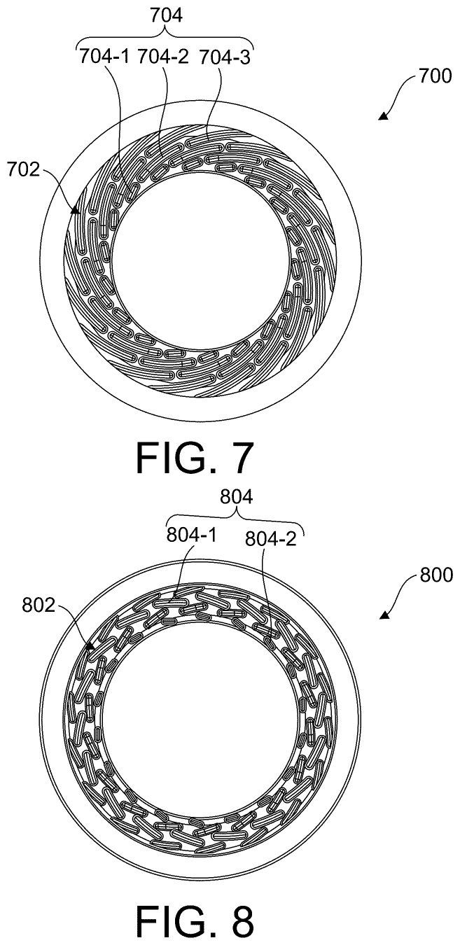

FIG. 7 shows another example of an endring 700 that can be used with an electric motor. The endring 700 can be used with one or more other examples described elsewhere herein. The endring 700 has an annular shape and includes fins 702. The fins 702 project in a direction that can be parallel with the rotor axis. In some implementations, the fins 702 can form a nonzero angle with the rotor axis. The fins 702 can form arcs 704. At least one of the arcs 704 can include arc segments 704-1, 704-2, and 704-3 separated from each other by gaps.

FIG. 8 shows another example of an endring 800 that can be used with an electric motor. The endring 800 can be used with one or more other examples described elsewhere herein. The endring 800 has an annular shape and includes fins 802. The fins 802 project in a direction that can be parallel with the rotor axis. In some implementations, the fins 802 can form a nonzero angle with the rotor axis. The fins 802 can form arcs 804. The arcs 804 can be substantially linear. Here, arcs 804-1 and 804-2 have different orientations from each other.

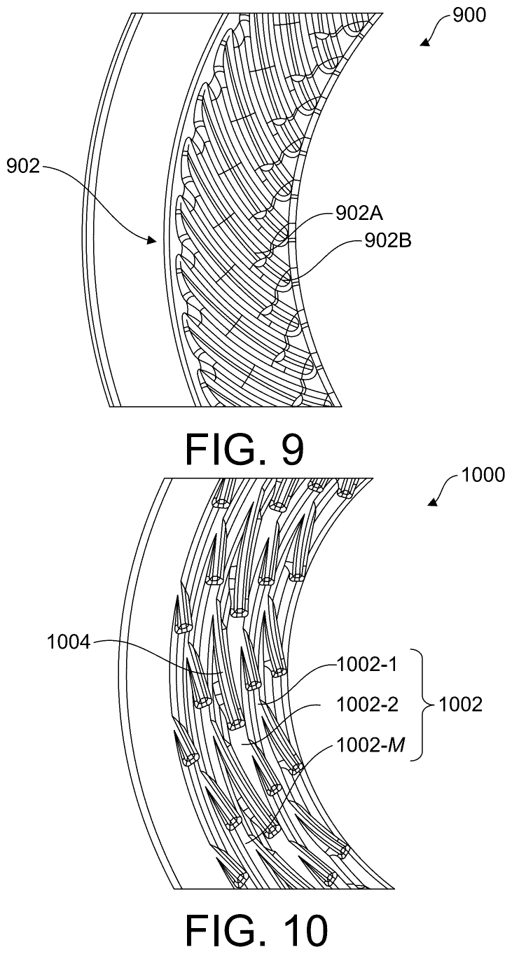

FIG. 9 shows another example of an endring 900 that can be used with an electric motor. The endring 900 can be used with one or more other examples described elsewhere herein. The endring 900 which is here partially shown has an annular shape and includes fins 902. The fins 902 project in a direction that can be parallel with the rotor axis. In some implementations, the fins 902 can form a nonzero angle with the rotor axis. The fins 902 can form arcs that have varying height parallel with the rotor axis (e.g., the height being in a direction that is perpendicular to the plane of the drawing in the present illustration). For example, one of the arcs here includes a portion 902A having a first height and a portion 902B having a second height, wherein the first height is different from the second height.

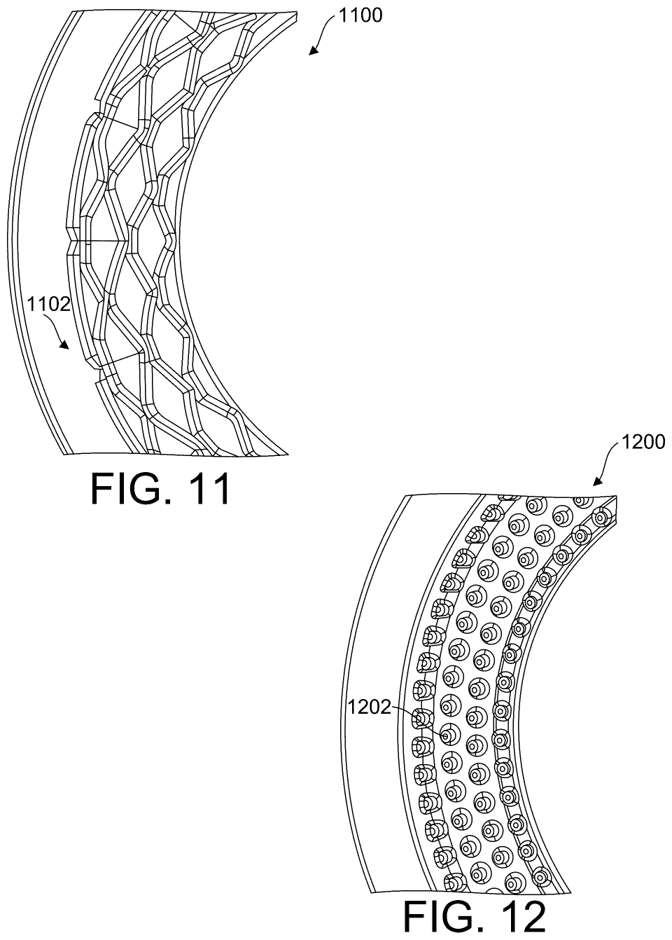

FIG. 10 shows another example of an endring 1000 that can be used with an electric motor. The endring 1000 can be used with one or more other examples described elsewhere herein. The endring 1000 which is here partially shown has an annular shape and has a stepped profile. The stepped profile includes concentric steps 1002. Concentric steps 1002-1, 1002-2, . . . , 1002-M can be used, where M=2, 3, . . . . In some implementations, the concentric steps 1002 have heights such that their respective distances from a rotor body increase with increasing diameter of the concentric steps 1002. The endring 1000 includes arcs 1004 on the concentric steps 1002. The arcs 1004 project in a direction that can be parallel with the rotor axis. In some implementations, the arcs 1004 can form a nonzero angle with the rotor axis.

FIG. 11 shows another example of an endring 1100 that can be used with an electric motor. The endring 1100 can be used with one or more other examples described elsewhere herein. The endring 1100 which is here partially shown has an annular shape and includes fins 1102. The fins 1102 project in a direction that can be parallel with the rotor axis. In some implementations, the fins 1102 can form a nonzero angle with the rotor axis. The fins 1102 form a diamond pattern on the endring 1100.

FIG. 12 shows another example of an endring 1200 that can be used with an electric motor. The endring 1200 can be used with one or more other examples described elsewhere herein. The endring 1200 which is here partially shown has an annular shape and includes pin fins 1202. The pin fins 1202 project in a direction that can be parallel with the rotor axis. In some implementations, the fins 1202 can form a nonzero angle with the rotor axis.

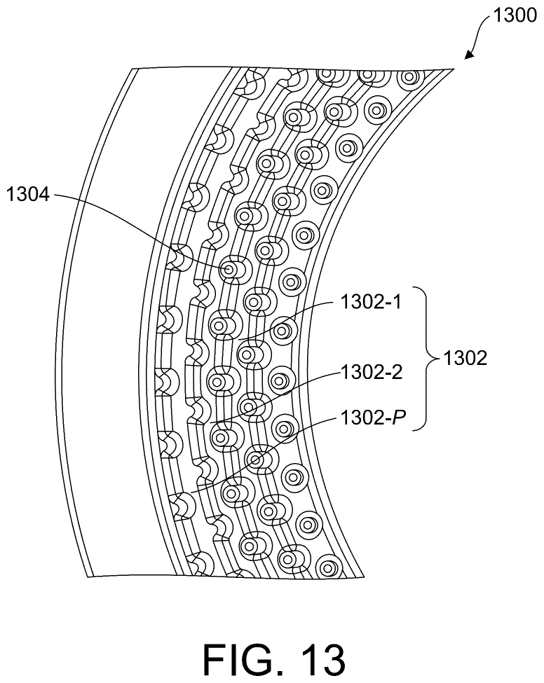

FIG. 13 shows another example of an endring 1300 that can be used with an electric motor. The endring 1300 can be used with one or more other examples described elsewhere herein. The endring 1300 which is here partially shown has an annular shape and has a stepped profile. The stepped profile includes concentric steps 1302. Concentric steps 1302-1, 1302-2, . . . , 1302-P can be used, where P=2, 3, . . . . In some implementations, the concentric steps 1302 have heights such that their respective distances from a rotor body increase with increasing diameter of the concentric steps 1302. The endring 1300 includes pin fins 1304 on the concentric steps 1302. The pin fins 1304 project in a direction that can be parallel with the rotor axis. In some implementations, the pin fins 1304 can form a nonzero angle with the rotor axis. The pin fins 1304 can straddle adjacent ones of the concentric steps 1302.

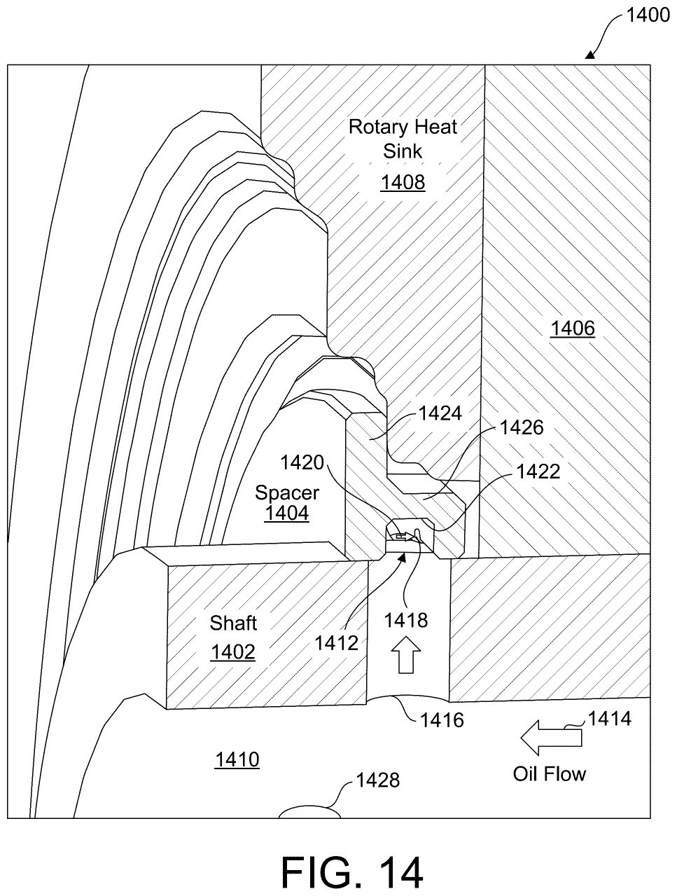

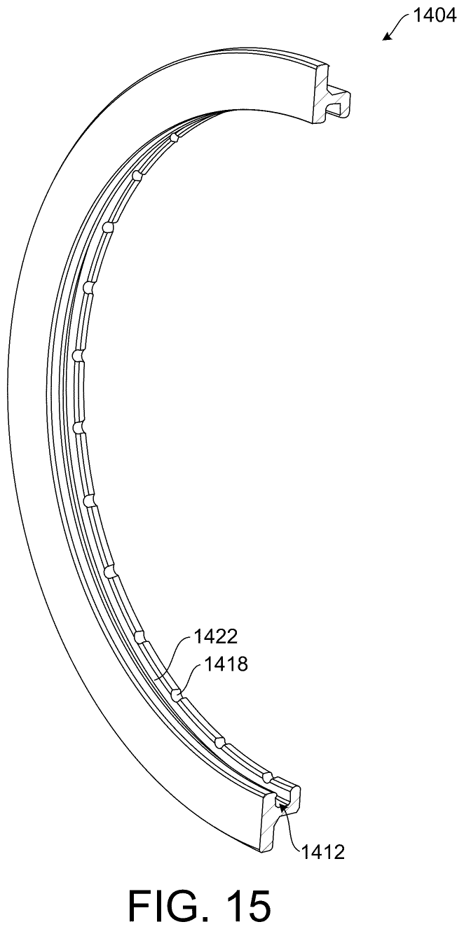

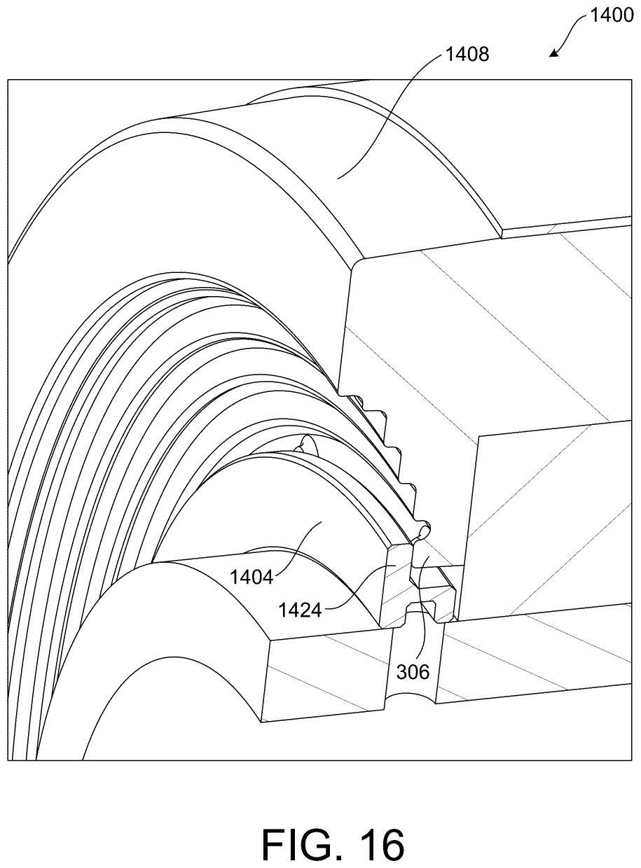

FIG. 14 shows an example section of a rotor 1400 having a rotor shaft 1402 with a spacer 1404. FIG. 15 shows an example section of the spacer 1404 of FIG. 14. The rotor 1400 or any component thereof can be used with one or more other examples described elsewhere herein. The rotor 1400 has a rotor body 1406 that can include individual rotor laminations. The rotor 1400 has an endring 1408 that can serve as a rotary heat sink. The rotor shaft 1402 has a hollow interior 1410 and is configured for rotation about a rotor axis inside a stator of an electric motor.

The spacer 1404 is an annular element positioned around the rotor shaft 1402. The spacer 1404 forms an internal cavity 1412 to receive fluid from the hollow interior 1410. The internal cavity 1412 can form an annulus inside the spacer 1404. A fluid flow can be provided inside the hollow interior 1410 as schematically illustrated by an arrow 1414. For example, the fluid flow can provide that differential gears inside the rotor shaft 1402 (e.g., a so-called active core) are lubricated by oil. The rotor shaft 1402 can have at least one radial outlet 1416 from the hollow interior 1410. Due to centrifugal force on the liquid as a result of rotation of the rotor shaft 1402, the radial outlet 1416 can allow the liquid to flow into the internal cavity 1412. When multiple radial outlets are used, they can be positioned axisymmetrically about the rotor axis. For example, in the rotor 1400 the axisymmetrically positioned radial outlets are evenly spaced about the rotor axis. Liquid can exit the internal cavity 1412 through at least one outlet 1418 as schematically illustrated by an arrow 1420. The outlets 1418 can be evenly distributed around the spacer 1404.

An area 1422 is a radially outermost portion of the annulus of the internal cavity 1412. That is, the area 1422 corresponds to a farthest distance from the rotor axis that liquid can be present inside the spacer 1404. The outlet 1418, on the other hand, is positioned radially inward of (closer to the rotor axis than) the area 1422. That is, the outlet 1418 is positioned radially inward of the radially outermost portion of the annulus of the internal cavity 1412. This can allow an amount of liquid to be collected in the annulus before any liquid begins exiting the spacer 1404 through any of the outlets 1418. For example, this can ensure that the liquid is evenly distributed and will be applied to the entirety of the endring 1408. The outlet 1418 can be at least partially bounded by the rotor shaft 1402.

The profile of the spacer 1404 (as viewed in section) can have a shape of a lowercase letter h (e.g., as shown, or a different h-shape). The profile of the spacer 1404 can include an ascender portion 1424 that extends in a radial direction from the rotor axis. For example, the ascender portion 1424 can abut the endring 1408 (e.g., a pin of the endring, such as the pin 306 in FIG. 3). The profile of the spacer 1404 can include an arch portion 1426 that is connected to the ascender portion 1424. The arch portion 1426 can at least partially form the outlet 1418 from the internal cavity 1412.

That is, liquid can be centrifugally flowed into the spacer 1404, and can exit the spacer 1404 through the at least one outlet 1418 from the internal cavity 1412. Having multiple instances of the outlet 1418 in the spacer 1404 can be a more effective way of evenly distributing the liquid than increasing the number of instances of the radial outlet 1416 around the rotor shaft 1402. For example, having too many of the radial outlet 1416 can introduce weakness in the rotor shaft 1402.

The spacer 1404 can also provide an advantageous flow direction of the liquid. The arrow 1420 indicates that the liquid has momentum in an axial direction (toward the rotor body 1406) when exiting the internal cavity 1412. Due to centrifugal motion, the liquid can be distributed over a surface of the endring 1408. In some implementations, the endring 1408 has a stepped design with two or more concentric steps. The presence of such steps can in a sense allow the liquid (e.g., oil) to be used multiple times while it is flowing across the endring surface. For example, when the endring 1408 includes six concentric steps, oil that flows across such steps can be said to be used six times. Other numbers of steps (more or fewer) can be used.

In addition to the radial outlet 1416, the rotor shaft 1402 can have one or more radial outlets 1428. That is, the rotor shaft 1402 can have multiple radial outlets from the hollow interior 1410. The multiple radial outlets can be evenly distributed around a circumference of the rotor shaft 1402.

The above examples illustrate that an electric motor (e.g., the electric motor 110 in FIG. 1B) can include a stator (e.g., the stator 114); a rotor (e.g., the rotor 1400) comprising a rotor shaft (e.g., the rotor shaft 1402) having a hollow interior (e.g., the hollow interior 1410) and being configured for rotation inside the stator about a rotor axis, the rotor shaft having at least one inlet (e.g., the inlet 212 in FIG. 2) into the hollow interior and at least one radial outlet (e.g., the radial outlet 1416) from the hollow interior; and a rotor body (e.g., the rotor body 1406) and an endring (e.g., the endring 1408) positioned at an end of the rotor body along the rotor axis; and a spacer (e.g., the spacer 1404) forming an internal cavity (e.g., the internal cavity 1412) to receive fluid from the hollow interior, the spacer having at least one outlet (e.g., the outlet 1418) from the internal cavity.

FIG. 16 shows another example section of the rotor 1400 of FIG. 14. Here, the endring 1408 has multiple instances of the pin 306. In some implementations, the spacer 1404 (e.g., the ascender portion 1424) can abut the pins 306. For example, the liquid exiting the spacer 1404 can flow through gaps formed between the pins 306.

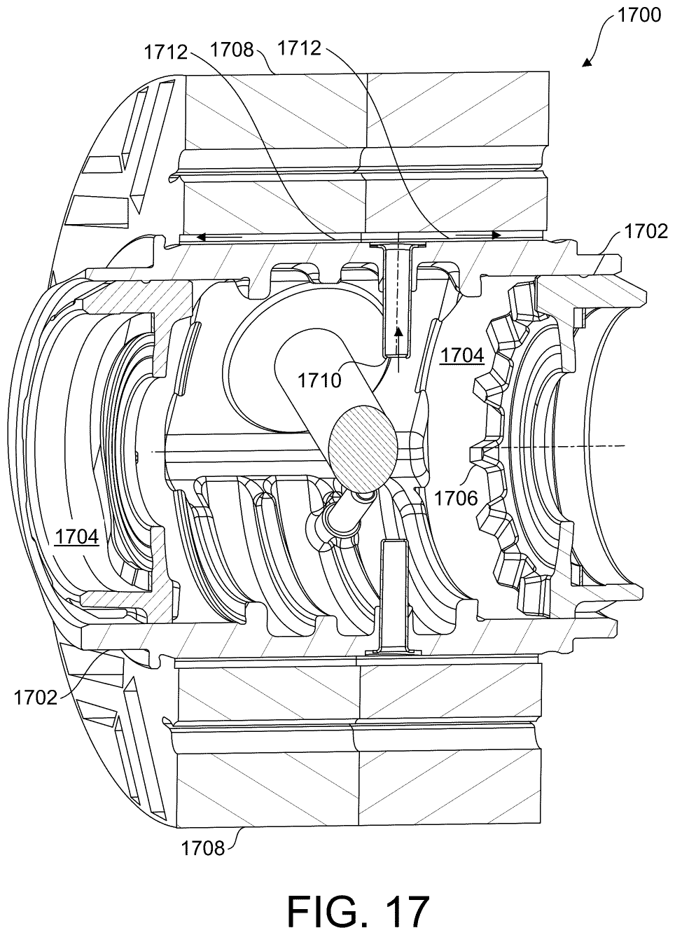

FIG. 17 shows an example section of a rotor 1700. The rotor 1700 or any component thereof can be used with one or more other examples described elsewhere herein. The rotor 1700 has a rotor shaft 1702 with a hollow interior 1704, differential gears 1706 positioned in the hollow interior 1704, and a rotor body 1708 that can include individual rotor laminations. The rotor 1700 can be designed for any of multiple types of electric motors. In this example, the rotor 1700 has cavities in the rotor body for permanent magnets.

The rotor shaft 1702 has at least one radial outlet 1710 from the hollow interior 1704. The radial outlet 1710 can be positioned between an axial end of the rotor body 1708 and an opposite axial end of the rotor body 1708 (e.g., as shown). For example, the radial outlet 1710 can be positioned in an axial middle between the axial ends. The radial outlet 1710 can extend inward into the hollow interior 1704 (e.g., as shown). In some implementations, this is because differential gears 1706 (e.g., in an active core design) can be situated in the hollow interior 1704. Extending the radial outlet 1710 inward toward the rotor axis can ensure that a pool of liquid (e.g., oil) is present in the differentials for lubrication. The height of the radial outlet 1710 can be tailored to the application depending on what the fluid level should be in the differential. Making the radial outlet 1710 longer can provide a greater thickness of fluid (e.g., oil) inside the rotor shaft 1702. Providing a radial outlet such as the radial outlet 1710 can provide advantageous routing of liquid while not losing efficiency in the electric motor (e.g., without losing range of the electric vehicle). A liquid (e.g., oil) can be sprayed into the rotor shaft 1702 and can collect in the differential; the liquid can then flow out between the rotor stack (e.g., laminations of the rotor body) and the rotor shaft 1702. Without a radial outlet for the liquid, the liquid could drain through high-speed bearings of the electric motor, thereby increasing bearing losses and decreasing the efficiency. In other implementations (e.g., where no differentials are situated in the hollow interior 1704), the radial outlet 1710 can instead be formed by a passage through the rotor shaft. When multiple radial outlets are used, they can be positioned axisymmetrically about the rotor axis. In the rotor 1700 multiple instances of the radial outlet 1710 (three of which are visible in the illustration) are positioned axisymmetrically about the rotor axis. For example, the positions of the multiple instances of the radial outlet 1710 can be characterized as forming an X shape when viewed along the rotor axis.

The rotor 1700 has an axial channel 1712 coupled to the radial outlet 1710. The axial channel 1712 is positioned between the rotor body 1708 and the rotor shaft 1702. For example, the axial channel 1712 can be at least partially formed by a female key in the rotor body 1708. The axial channel 1712 can facilitate that liquid (e.g., oil) can have an axial momentum when provided to an endring of the electric motor (e.g., any of the endrings and electric motors described herein). A spacer (e.g., any of the spacers described herein) can receive the liquid from the axial channel 1712 and distribute the liquid onto the endring.

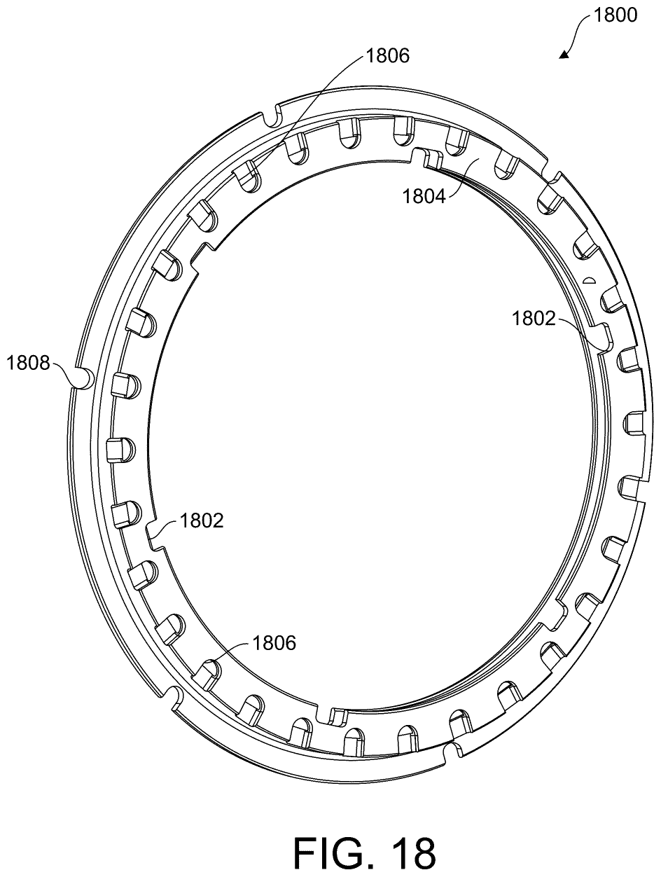

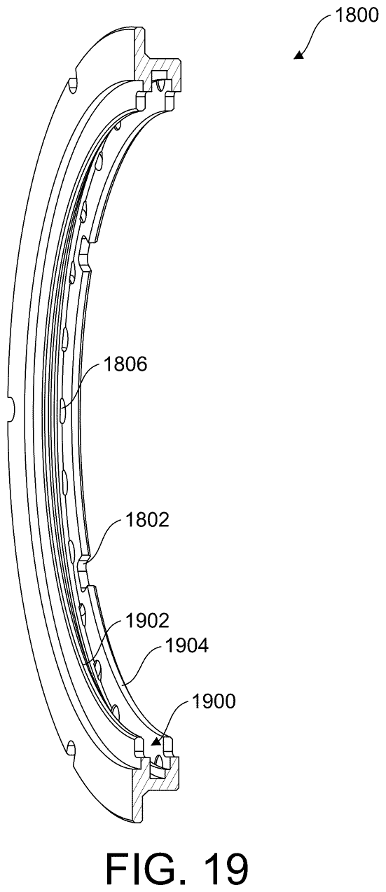

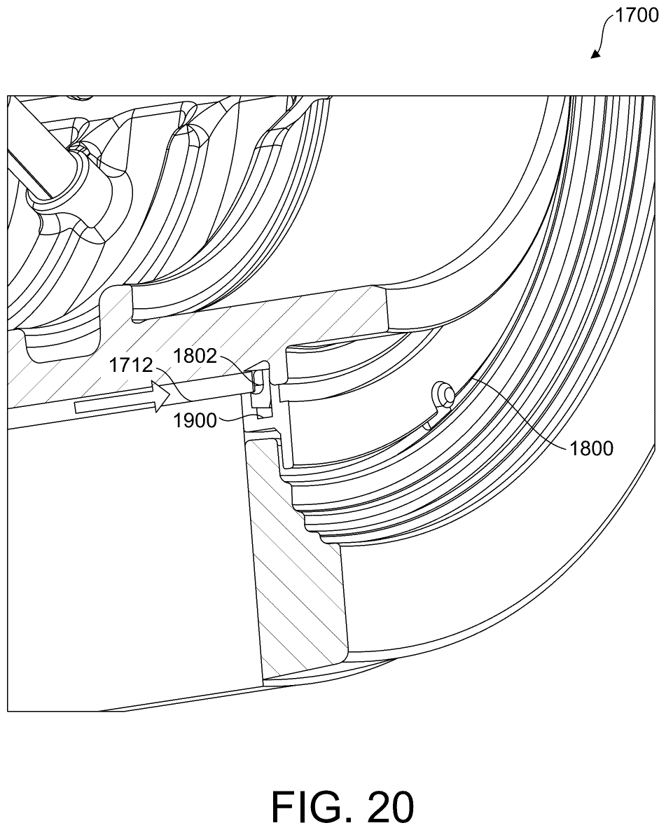

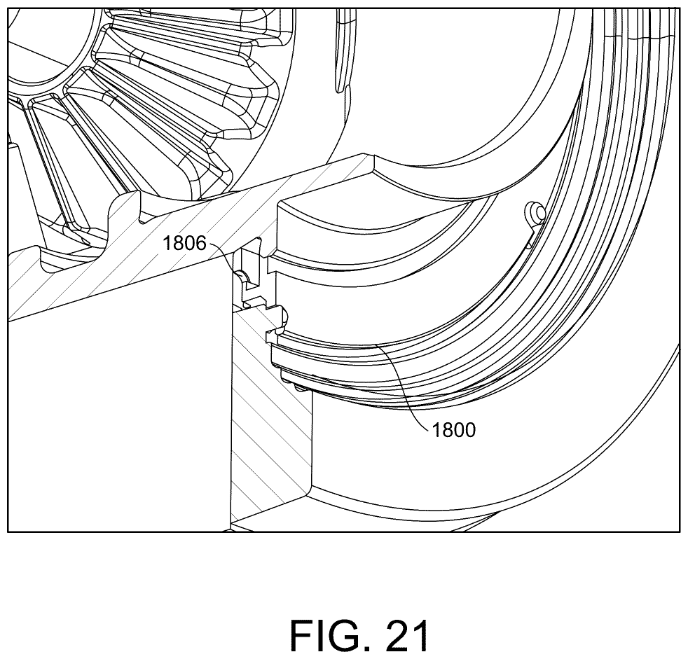

FIG. 18 shows an example of a spacer 1800 that can be used with the rotor of FIG. 17. FIG. 19 shows another example section of the spacer 1800 of FIG. 18. FIG. 20 shows another example section of the rotor 1700 of FIG. 17. FIG. 21 shows another example section of the rotor 1700 of FIG. 17. The spacer 1800 can be used with one or more other examples described elsewhere herein.

The spacer 1800 is an annular element that can be positioned around a rotor shaft (e.g., the rotor shaft 1702 in FIG. 17). The spacer 1800 forms an internal cavity 1900 (e.g., FIG. 19) that can be an annulus inside the spacer 1800, the annulus extending around the spacer 1800. The internal cavity 1900 can at least in part be defined by walls of the spacer 1800 and by a surface of the rotor shaft. For example, edges 1902 and 1904 of the spacer 1800 can be configured to abut the surface of the rotor shaft. The spacer 1800 has one or more inlets 1802 to the internal cavity 1900. The inlet 1802 is configured for liquid to flow from an axial channel (e.g., the axial channel 1712 in FIG. 17) into the internal cavity 1900. In some implementations, the inlet 1802 faces toward the rotor body along a rotor axis and is coupled to the axial channel. For example, a face 1804 of the spacer 1800 can be configured to be in contact with the rotor body.

The spacer 1800 has one or more outlets 1806 from the internal cavity 1900. The outlets 1806 are configured for liquid to flow out of the internal cavity 1900 and toward an endring of the rotor. The outlets 1806 faces toward the rotor body along the rotor axis. Here, the outlets 1806 and the inlets 1802 are formed in the face 1804. One or more keys 1808 can be formed in the spacer 1800 to ensure proper alignment relative to the rotor shaft. For example, the inlets 1802 can be aligned with the respective ones of the axial channels 1712 by the keys 1808.

The above examples illustrate that an electric motor (e.g., the electric motor 110 in FIG. 1B) can include a stator (e.g., the stator 114); a rotor shaft (e.g., the rotor shaft 1702) having a hollow interior (e.g., the hollow interior 1704) and be configured for rotation inside the stator about a rotor axis, the rotor shaft having at least one inlet into the hollow interior and at least one radial outlet (e.g., the radial outlet 1710) from the hollow interior; a rotor (e.g., the rotor 1700) comprising a rotor body (e.g., the rotor body 1708), and an endring (e.g., any of the endrings herein) positioned at an end of the rotor body along the rotor axis; and a spacer (e.g., the spacer 1800) positioned on the rotor shaft adjacent the endring; the spacer forming an internal cavity (e.g., the internal cavity 1900) to receive fluid from the hollow interior, the spacer having an outlet (e.g., the outlet 1806) from the internal cavity that faces toward the rotor body along the rotor axis.

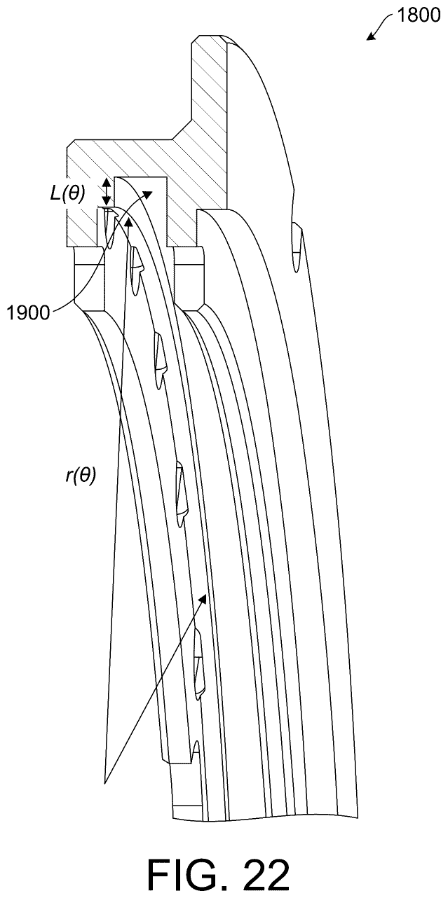

FIG. 22 shows another example section of the spacer 1800 of FIG. 18. The internal cavity 1900 can have a depth L that varies with (e.g., is a function of) angular position about the rotor axis (e.g., L (0), where 0 is the angle around the rotor shaft). The depth L may not be the whole radial difference (sometimes referred to as dr) represented by the internal cavity 1900. Rather the depth L can be a distance from the outlet diameter of the internal cavity 1900 to the radially outer location of the outlets 1806. That is, this can be the distance from the outer diameter of the internal cavity 1900 to the closest point in the outlet 1806. Here, r (0) indicates the distance from the axis of rotation to the outer diameter of each of the outlets 1806 at respective angular positions. That is, this is the distance from the farthest point of each of the outlets 1806 to the axis of rotation. That is, the radius of the internal cavity 1900 can be defined as the sum of r (0) and L (0). The depth L (0) can help provide a better distribution of liquid onto the endring. In some implementations, the variations in the depth L (0) can affect some or all of the outlets 1806 to reduce the occurrence that a disproportionate amount of liquid flows through the outlets 1806 that are closer to the inlets 1802. For example, the depth L (0) can provide one or more of the outlets 1806 positioned closer to the inlet 1802 with a relatively smaller opening than one or more of the outlets 1806 positioned further from the inlet 1802. That is, for an outlet positioned closer to the inlet the L (0) can be greater, which means the r (0) is smaller and the outlet is smaller.

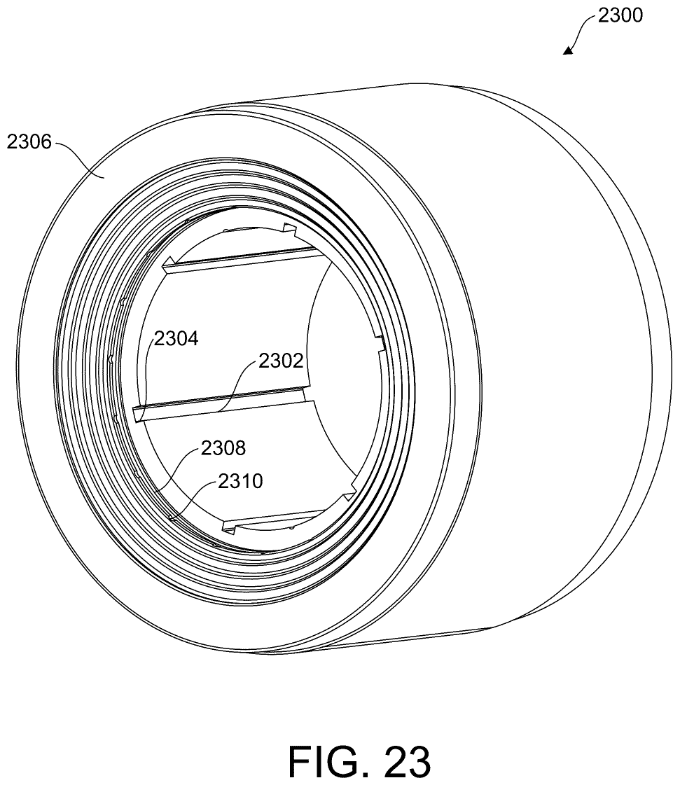

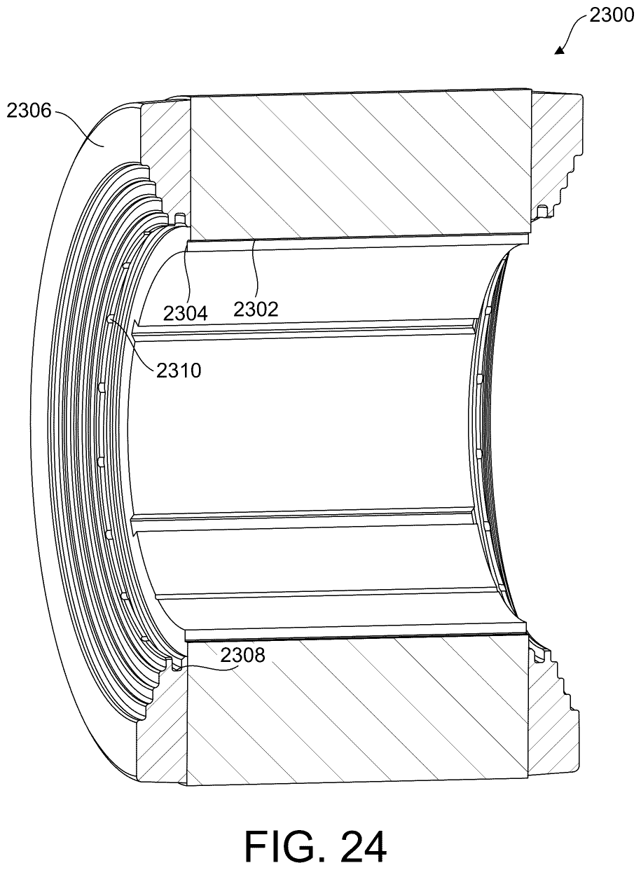

FIG. 23 shows another example of a rotor 2300. FIG. 24 shows an example section of the rotor 2300 of FIG. 23. The rotor 2300 shows an example where a spacer forming an internal cavity is integrated into an endring. The rotor 2300 can be used with one or more other examples described elsewhere herein.

The rotor 2300 has female keys 2302 forming respective channels through which liquid can flow. For example, that liquid can enter the channels from radial outlets in a rotor shaft. Ends 2304 of the female keys 2302 are located at the ends of the rotor body. The liquid can exit the channels at the ends 2304 and move radially outward due to centrifugal forces. The rotor 2300 has an endring 2306 in which an internal cavity 2308 is formed. That is, a spacer (e.g., as described in other examples herein) forming the internal cavity 2308 can be said to be integrated into the endring 2306. The liquid is trapped in the internal cavity 2308. The spacer has outlets 2310 from the internal cavity 2308. Here, the outlets 2310 face away from the rotor body along the rotor axis. Sizes, spacing, and/or positioning of the outlets 2310 can be similar or identical to aspects described herein with reference to other outlets from internal cavities (including, but not limited to, the outlets 1418 of FIG. 14, or the outlets 1806 of FIG. 18). In some implementations, a significant number of the outlets 2310 can be present (e.g., as shown), which can create a uniform flow of liquid on the endring 2306 for cooling performance. Integrating the spacer into the endring 2306 can simplify design and manufacturing.

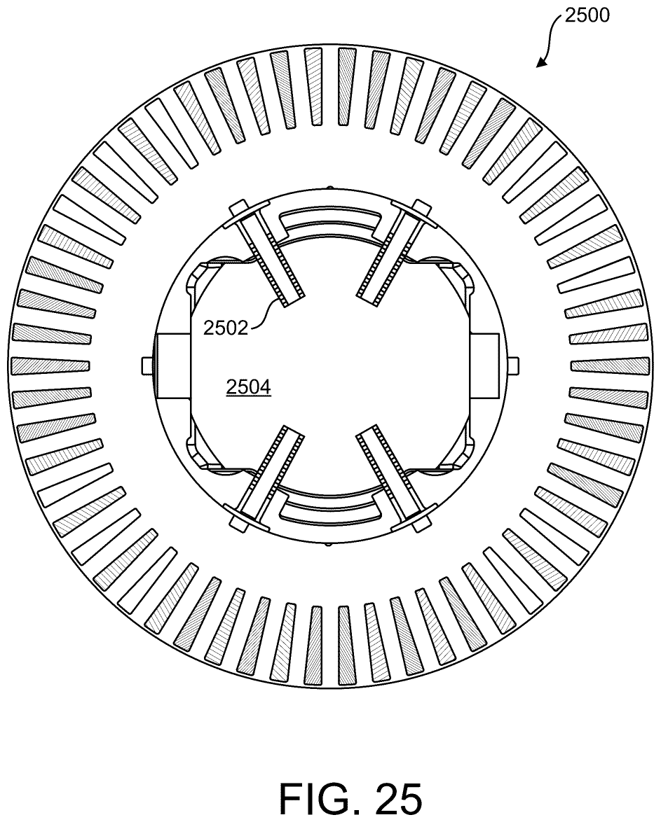

FIG. 25 shows an example section of a rotor 2500 having radial outlets 2502 that are axisymmetrical. The radial outlets 2502 can facilitate flow of a fluid out of a hollow interior 2504 of the rotor 2500. That is, while there are here four instances of the radial outlets 2502 that are axisymmetrical about the rotor axis, they are not evenly spaced from each other. Rather, the radial outlets 2502 can be characterized as forming an X shape when viewed along the rotor axis. The rotor 2500 can be designed for any of multiple types of electric motors. In this example, the rotor 2500 has cavities for the bars of an induction motor.

The terms “substantially” and “about” used throughout this Specification are used to describe and account for small fluctuations, such as due to variations in processing. For example, they can refer to less than or equal to +5%, such as less than or equal to +2%, such as less than or equal to #1%, such as less than or equal to +0.5%, such as less than or equal to +0.2%, such as less than or equal to +0.1%, such as less than or equal to +0.05%. Also, when used herein, an indefinite article such as “a” or “an” means “at least one”.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. An electric motor comprising:
a stator;
a rotor comprising:
a rotor shaft having a hollow interior and configured for rotation inside the stator about a rotor axis, the rotor shaft having at least one inlet into the hollow interior and at least one radial outlet from the hollow interior; and
a rotor body and an endring at an end of the rotor body along the rotor axis; and
a spacer forming an internal cavity to receive fluid from the hollow interior, the spacer having an outlet from the internal cavity.

2. The electric motor of claim 1, wherein the rotor shaft has multiple radial outlets from the hollow interior.

3. The electric motor of claim 2, wherein the multiple radial outlets are axisymmetrically distributed around a circumference of the rotor shaft.

4. The electric motor of claim 3, wherein the multiple radial outlets are evenly distributed around the circumference of the rotor shaft.

5. The electric motor of claim 1, wherein the spacer is an annular element positioned around the rotor shaft, and wherein the internal cavity forms an annulus inside the spacer.

6. The electric motor of claim 5, wherein the outlet from the internal cavity is positioned radially inward of a radially outermost portion of the annulus.

7. The electric motor of claim 1, wherein the endring has a stepped profile that includes concentric steps.

8. (canceled)

9. The electric motor of claim 1, wherein the spacer is integrated into the endring, wherein the internal cavity is formed in the endring, and wherein the outlet from the internal cavity faces away from the rotor body along the rotor axis.

10. (canceled)

11. (canceled)

12. The electric motor of claim 7, further comprising pin fins at some or all of the concentric steps.

13. (canceled)

14. The electric motor of claim 12, wherein the pin fins are angularly equally spaced from each other on at least one of the concentric steps.

15. The electric motor of claim 14, wherein a first group of the pin fins are aligned with each other in a first radial direction from the rotor axis, and wherein a second group of the pin fins are aligned with each other in a second radial direction from the rotor axis.

16. (canceled)

17. (canceled)

18. (canceled)

19. (canceled)

20. The electric motor of claim 12, wherein each of the pin fins straddles adjacent ones of the concentric steps.

21. (canceled)

22. (canceled)

23. (canceled)

24. (canceled)

25. The electric motor of claim 1, further comprising fins on the endring.

26. (canceled)

27. (canceled)

28. (canceled)

29. The electric motor of claim 25, wherein the fins form arcs on the endring.

30. (canceled)

31. (canceled)

32. The electric motor of claim 29, wherein at least one of the arcs includes arc segments separated by gaps.

33. (canceled)

34. (canceled)

35. (canceled)

36. (canceled)

37. The electric motor of claim 1, wherein the endring has a stepped profile that includes concentric steps, the electric motor further comprising arcs on the concentric steps.

38. (canceled)

39. (canceled)

40. The electric motor of claim 1, wherein the outlet from the internal cavity is at least partially bounded by the rotor shaft.

41. The electric motor of claim 1, wherein the radial outlet from the hollow interior is positioned between the end of the rotor body and an opposite end of the rotor body, the electric motor further comprising an axial channel coupled to the radial outlet from the hollow interior, the axial channel positioned between the rotor body and the rotor shaft.

42. (canceled)

43. (canceled)

44. The electric motor of claim 41, wherein the spacer is positioned on the rotor shaft adjacent the endring, and wherein the outlet faces toward the rotor body along the rotor axis.

45. The electric motor of claim 44, wherein the spacer has an inlet to the internal cavity, the inlet facing toward the rotor body along the rotor axis and being coupled to the axial channel.

46. (canceled)

47. (canceled)

48. (canceled)

49. (canceled)

50. (canceled)

51. (canceled)

52. (canceled)

53. (canceled)

54. (canceled)
